(19) United States
(12) Patent Application Publication
(10) Pub. No.: US 2004/0199771 A1
(43) Pub. Date: Oct. 7, 2004

(54) Method for tracing a security breach in highly distributed content

(75) Inventors: Glenn A. Morten, Bellevue, WA (US); Brian Baker, Bellevue, WA (US); Reza Rassool, Stevenson Ranch, CA (US)

Correspondence Address: DARBY & DARBY P.C., P. O. BOX 5257, NEW YORK, NY, 10150-5257, US

(73) Assignee: Widevine Technologies, Inc., Seattle, WA

(21) Appl. No.: 10/817,124

(22) Filed: Apr. 2, 2004

Related U.S. Application Data
(60) Provisional application No. 60/460,709, filed on Apr. 4, 2003.

(51) Int. Cl. H04L 9/00

(52) U.S. Cl. 713/176

(57) ABSTRACT

Method and devices are directed to uniquely identifying content in a highly distributed content delivery system such that an origin of unauthorized content use may be more accurately determined. Content received from a content owner is distributed to a persistent security database and a key manager, which manages encryption and decryption keys for content that may be already encrypted. Decrypted content is fingerprinted or watermarked by a fingerprinter/watermarker module such that a recipient of content is identifiable, and saved in a separate database. Information about fingerprinted/watermarked content may be reported back to content owner for tracking purposes. A key wrap module wraps and attaches aggregator's encryption key to the content before it is transmitted to downstream service operators or users.

### RELATED APPLICATION

This application claims the benefit of U.S. Provisional Application Serial No. 60/460,709 filed Apr. 4, 2003, the benefit of the earlier filing date of which is hereby claimed under 35 U.S.C. § 119 (e) and further incorporated by reference.

### FIELD OF THE INVENTION

The present invention relates generally to digital copy protection and more particularly to employing unique identifiers to highly distributed content.

### BACKGROUND OF THE INVENTION

Recent advances in the telecommunications and electronics industry, and, in particular, improvements in digital compression techniques, networking, and hard drive capacities have led to growth in new digital services to a user's home. For example, such advances have provided hundreds of cable television channels to users by compressing digital data and digital video, transmitting the compressed digital signals over conventional coaxial cable television channels, and then decompressing the signals in the user's receiver. One application for these technologies that has received considerable attention recently includes video-on-demand (VOD) systems where a user communicates with a service operator to request content and the requested content is routed to the user's home for enjoyment. The service operator typically obtains the content from an upstream content provider, such as a content aggregator or distributor. The content aggregators, in this market stream, in turn, may have obtained the content from one or more content owners, such as movie studios.

While the video-on-demand market stream provides new opportunity for profits to content owners, it also creates a tremendous risk for piracy of the content. Such risk for piracy may arise at any place in the market stream that the content is exposed. Without appropriate protection, the content can be illicitly intercepted, stolen, copied, and redistributed, thus depriving content owners of their profits.

Furthermore, the content owner is often unable to determine where in the market stream the exposed content was used in an unauthorized manner. Without a way of determining where a security breach arose, the content owner may be unable to take appropriate action to minimize further piracy.

Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a functional block diagram illustrating one embodiment of an operating environment in which the invention may be implemented;

FIG. 2 is a functional block diagram of a network device in which an aggregator employing security components for uniquely identifying content in video-on-demand systems may be embodied;

FIG. 3 is a flow diagram generally illustrating one embodiment of an process of uniquely identifying highly distributed content;

FIG. 4 is a flow diagram illustrating an embodiment of a process of wrapping encrypted content; and

FIG. 5 is a flow diagram illustrating an embodiment of a process of uniquely watermarking unencrypted content, in accordance with the present invention.

### DETAILED DESCRIPTION OF THE PREFERRED EMBODIMENT

The present invention now will be described more fully hereinafter “with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” means a direct connection between the things that are connected, or an indirect connection through one or more either passive or active intermediary devices or components. The meaning of “a,” “an,” and “the” include plural references. The meaning of “in” includes “in” and “on.”

The terms “comprising,” “including,” “containing,” “having,” and “characterized by,” refer to an open-ended or inclusive transitional construct and does not exclude additional, unrecited elements, or method steps. For example, a combination that comprises A and B elements, also reads on a combination of A, B, and C elements.

The phrase “in one embodiment,” as used herein does not necessarily refer to the same embodiment, although it may. Similarly, the phrase “in another embodiment,” as used herein does not necessarily refer to a different embodiment, although it may.

Briefly stated, the present invention provides a method of uniquely identifying content in a highly distributed content delivery system such that an origin of unauthorized content use may be more accurately determined.

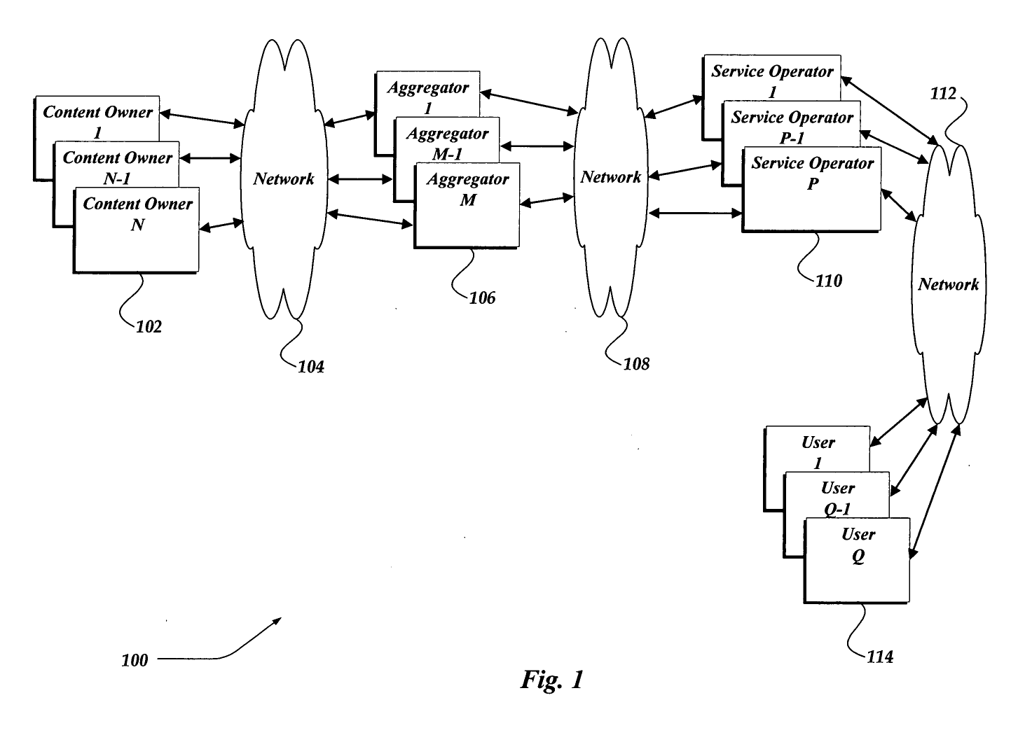

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes content owner(s) 102, aggregator(s) 106, service operator(s) 110, user(s) 114, and networks 104, 108, and 112. Content owner(s) 102 are coupled to and in communication with network 104. Aggregator(s) 106 are coupled to and in communication with network 104 and network 108. Service operator(s) 110 are coupled to and in communication with network 108 and network 112. User(s) 114 are coupled to and in communication with network 112.

Content owner(s) 102 include producers, developers, and owners of content that can be distributed to user(s) 114. Such content may include pay-for-view or similar time and subscription television, movies, interactive video games, interactive news television, catalogue browsing, distance learning, video conferencing, and the like. Moreover, content controlled by content owner(s) 102 is not limited to video content only, and may include audio only services, without departing from the scope or spirit of the present invention. Thus, content is intended to include, but not be limited to, audio, video, still images, text, graphics, and the like.

Aggregator(s) 106 may include distributors and other businesses that obtain rights to distribute content from content owner(s) 102. Aggregator(s) 106 may obtain the rights to distribute from one or more content owners. Each aggregator may also repackage, store, and schedule content for subsequent sale or license to other aggregator(s) 106 and service operator(s) 110. Also, aggregator(s) 106 may be enabled to inspect the quality of the content prior to acceptance. Moreover, content owner 102 may function in the role of both a content owner and an aggregator or distributor of content.

Service operator(s) 110 may include businesses that are directed at providing content to user(s) 114. Service operator(s) 110 includes businesses that provide and manage the infrastructure between user(s) 114 and the service operator's facilities. Moreover, content owner(s) 102 or aggregator(s) 106 may function in the role of service operator without departing from the spirit or scope of the present invention.

User(s) 114 may include end-users and consumers of content. User(s) 114 may employ various devices to enjoy the content, including but not limited to television appliances, digital recorders, set-top boxes, mobile device, PDAs, personal computers, jukeboxes, and the like. User(s) 114 may request content delivery directly from content owner(s) 102, or at any point along the market stream (e.g., from aggregator(s) 106, or service operator(s) 110). Moreover, user(s) 114 may receive content through multiple sources within the market stream. Additionally, user(s) 114 may select to transfer or share content between other users. User(s) 114 may further select to pay for content out of band of operating environment 100, or through networks 104, 108, and 112 to an upstream market seller, and the like.

Networks 104, 108, and 112 are configured to couple one electronic device to another electronic device to enable them to communicate. Networks 104, 108, and 112 are enabled to employ any form of computer readable media for communicating information from one electronic device to another. Also, Networks 104,108, and 112 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), Asymmetric Digital Subscriber Lines (ADSL), Video Digital Subscriber Lines (VDSL), wireless links including satellite links, or other communications links known to those skilled in the art. Furthermore, remote computers and other related electronic devices could be remotely connected to either LANs or WANs via a modem and temporary telephone link. In essence, Networks 104, 108, and 112 include any communication method by which information may travel between electronic devices.

The term “modulated data signal” means a signal that has one or more of its characteristics set or changed in such a manner as to encode information in the signal. Carrierless AM/PM (CAP), Discrete Multitone Transmission (DMT), and Frequency Division Multiplexing (FDM) may be included as modulation techniques employed to generate the modulated data signal to transport content through operating environment 100 of FIG. 1.

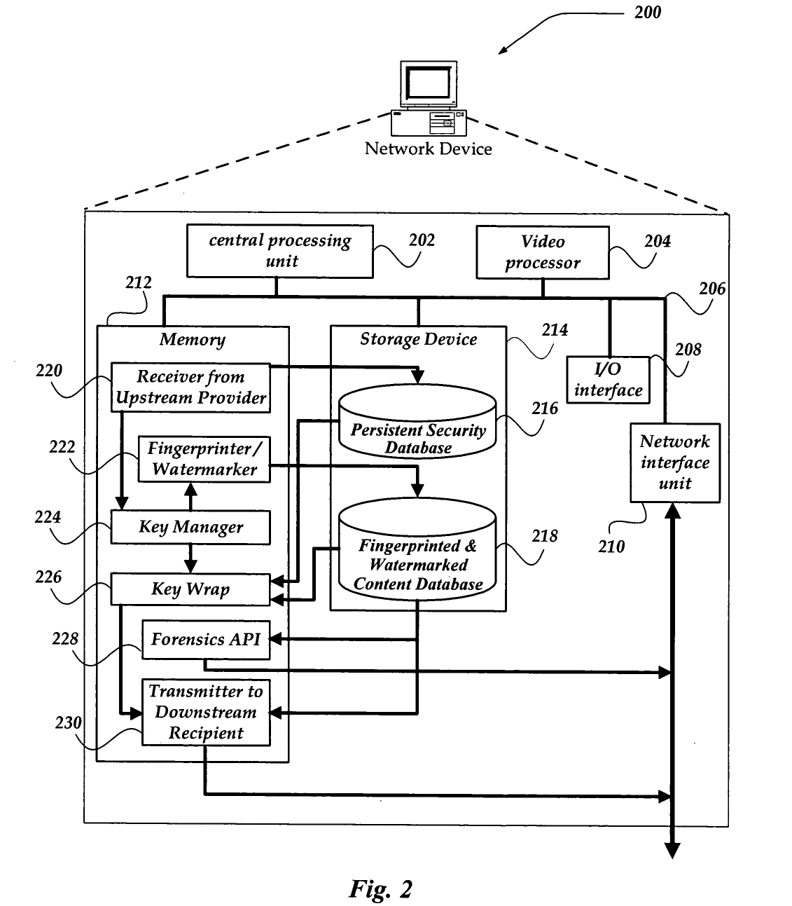

FIG. 2 illustrates a functional block diagram of network device 200 that may be embodied in content owner 102, aggregator 106, service operator 110, or user 114 of FIG. 1. It will be appreciated that not all components of network device 200 are illustrated, and that network device 200 may include more or less components than those shown in the figure. Network device 200 may operate, for example, as a portable or desktop computer with a network connection, a firewall, a gateway, a traffic management device, a distributor, a server array controller, or a proxy server. Individual components may also reside on distributed devices instead of one network device. The communications may take place over a network, such as networks 104 and 108 in FIG. 1, the Internet, or some other communications network. Components of service operator(s) 110, and user(s) 114 of FIG. 1 may also be employed in network device 200, without departing from the scope or spirit of the present invention.

As illustrated in FIG. 2, network device 200 includes central processing unit (CPU) 202, video processor 204, memory 212, storage device 214, input/output interface (I/O) 208, and a network interface unit 210 interconnected via a bus 206.

In one embodiment, memory 212 may store program code for receiver 220, fingerprinter/watermarker 222, key manager 224, key wrap 226, forensics Application Program Interface (API) 228, and transmitter 230. Storage device 214 may include persistent security database 216 and fingerprinted and watermarked content database 218. While these components are shown as computer programs in FIG. 2, it should be understood that each component may be implemented in special purpose hardware, such as programmed processors, and combination of hardware and software in integrated or distributed form.

Memory 212 generally includes random access memory (RAM), but may also include read only memory (ROM). Memory 212 generally stores operating system for controlling the operation of network device 200. The operating system may comprise an operating system such as UNIX, LINUX™, Windows™, and the like.

Memory 212 may include volatile and nonvolatile, removable and non-removable media implemented in any method or technology for storage of information, such as computer readable instructions, data structures, program modules or other data. Examples of media, in which memory 212 may be embodied, include RAM, ROM, EEPROM, flash memory or other memory technology.

Storage device 214 may include CD-ROM, digital versatile disks (DVD) or other optical storage, magnetic cassettes, magnetic tape, magnetic disk storage or other magnetic storage devices, or any other medium that can store the information and that can be accessed by a computing device.

Network interface unit 210 is constructed for use with various communication protocols including the TCP/IP and UDP/IP protocol. Network interface unit 210 may include or interface with circuitry and components for transmitting packets, and the like, over a wired and/or wireless communications medium. Network interface unit 210 is sometimes referred to as a transceiver, Network Interface Card (NIC), and the like. Network device 200 may also include an I/O interface 208 for communicating with external devices or users.

Network device 200 is configured to receive content from content owner(s) 102 through network interface unit 210. Typically, the content is encrypted, by an upstream market provider, such as content owner(s) 102. Receiver 220 receives the content and distributes it to other components such as persistent security database 216 and key manager 224. Receiver 220 may be embodied fully in software or a combination of special purpose hardware and software. Receiver 220 may also be implemented outside network device 200 in a distributed embodiment of the present invention

A user of network device 200 may desire to decrypt the content for various reasons. For example, the user of network device 200 may wish to examine the quality of the content prior to payment. Moreover, network device 200 may have a connection to service operator 110 that precludes transmission of encrypted content. The user of network device 200 may also wish to store the content in the clear, as unencrypted content.

Although depicted as program code in FIG. 2, key manager 224 may include software and hardware components to manage encryption/decryption keys for network device 200 that may be employed for signing of content, encrypting the content, and the like. Key manager 224, together with key exchange (not shown), is configured to manage decryption keys for content that has been encrypted by an upstream provider such as content owner 102. Additionally, key manager 224 may manage encryption access keys employed by key wrap 212 and distributed to service operator(s) 110, and the like.

Fingerprinter/watermarker 222 may include software and hardware components configured to provide fingerprinting and watermarking content that has been decrypted by key manager 224.

A fingerprint may be created by including a “decoder” in a content file. This “decoder” can be decoded to extract the message a creator made. A fingerprint can be embedded in the content substantially like a watermark (in this case a fingerprint will sometimes be referred to as a watermark) but it can also just be attached to the content, unlike a watermark. Moreover, watermarks and fingerprints may be invisible to the casual observer, further facilitating the claim of ownership, receipt of copyright revenues, or the success of prosecution for unauthorized use of the content. Typically, decrypted content is both watermarked and fingerprinted by fingerprinter/watermarker 222 to uniquely identify the distribution path and points of decryption of the content in the market stream.

Briefly, a watermark is a digital signal or pattern that is inserted into content such as a digital image, audio, video content, and the like. Because the inserted digital signal or pattern is not present in unaltered copies of the original content, the digital watermark may serve as a type of digital signature for the copied content. For example, watermarking may be employed to embed copyright notices into the content. A given watermark may be unique to each copy of the content so as to identify the intended recipient, or be common to multiple copies of the content such that the content source may be identified. An example of fingerprinting/watermarking techniques is preprocessing content, which involves storing potential replacement frames of selected streaming media data files for later substitution. Content to be watermarked is scanned and selected frames are extracted. Each extracted frame may be provided with a portion of a serial number, such as a single digit. The serial number may represent a unique identifier of a document source, or an intended client recipient. The portion of the serial number may be located in several frames. When a particular content is requested, the selected watermarked frames are employed to replace the unmarked frames in the original content. Another example of fingerprinting/watermarking techniques is dynamic content modification, which decompresses, modifies, and recompresses content data packets. The modified data packets are sent to requesting client, rather than the original content data packets. A further example of fingerprinting/watermarking techniques is dark frame replacement employs knowledge that many video content includes black frames. Black frames may be stored with watermarks identifying the source of the content. Black frames may also be watermarked with a unique requesting client identifier as a client requests the content. The watermarked black frames are employed to replace selected black frames on the fly as the content is transmitted to the requesting client.

Unencrypted content that has been fingerprinted and/or watermarked by fingerprinter/watermarker 222 may be stored in fingerprinted and watermarked content database 218. Fingerprinted and watermarked content database 218 may include virtually any data store configured to save unencrypted content for network device 200, including, but not limited to, a database, a text file, a spreadsheet, a folder, and the like.

Forensics API 228 may include hardware and related software directed towards providing market upstream content providers, such as content owner(s) 102, with information concerning the unencrypted content. Such information may include information about the watermark or fingerprint included in the content as well as registration and other traceability information, that content owner 102 may wish to track.

Persistent security database 216 may be part of storage device 214 and include hardware and related software directed towards receiving and storing of encrypted content. Persistent security database 216 may include virtually any data store, including, but not limited to, a database, a text file, a spreadsheet, a folder, and the like.

Key wrap 226 may include hardware and related software configured to provide an encryption key wrap to encrypted content as it is communicated to a market downstream recipient, such as service operator(s) 110. Key wrap 226 may also be configured to provide key unwrapping of wrapped encrypted content.

Key wrap 226 may include a content owner's symmetric encryption key that has been uniquely encrypted by an aggregator's encryption key. By encrypting symmetric encryption key with a particular aggregator's encryption key, only that aggregator should be able to decrypt the wrapped symmetric encryption key, and thereby access the encrypted content. Moreover, aggregator's encryption key, is the access key communicated out-of-band to that particular aggregator.

By wrapping and attaching the upstream content owner's encryption keys with a recipient's key a content owner may later determine the end-to-end flow of the content. More particularly, because the key wraps are uniquely associated with each downstream market recipient, a source of unauthorized distribution of content may be more easily identified. Encryption keys may also be regenerated based on a predetermined condition, thereby providing a conditional access system with rotating key wraps, without departing from the spirit or scope of the present invention.

Transmitter 230 receives content from components such as key wrap 226 and fingerprinted and watermarked content database 218, and distributes it through the network to other elements of the operating environment such as service operator(s) 110, user(s) 114. Transmitter 230 may be embodied fully in software or a combination of special purpose hardware and software. Transmitter 230 may also be implemented outside network device 200 in a distributed embodiment of the present invention.

A generalized operation of one embodiment will now be described with respect to FIGS. 1-2, in accordance with the present invention.

As shown in FIG. 1, content owner 102 may provide content to aggregator 106 through network 104. In so doing, content owner 102 may employ a bridge (not shown), and key manager 224 to uniquely encrypt the content as it is transmitted (i.e., encrypted on the fly) to aggregator 106. Moreover, content owner 102 may select to embed the content with a fingerprint or watermark that uniquely identifies content owner 102 and the particular recipient, aggregator 106.

As the encrypted content is received, aggregator 106 stores it in persistent security database 216 (FIG. 2). If aggregator 106 wishes to inspect the encrypted content, key manager 224 together with a decryption client (not shown) is employed to decrypt the content. As the content is decrypted, fingerprinter/watermarker 222 watermarks the content with a unique fingerprint. The fingerprinted/watermarked unencrypted content is stored in fingerprinted and watermarked content database 218.

Forensics API 228 may provide market upstream content providers, such as content owner(s) 102, with information concerning the unencrypted content. As described above, information provided to a market upstream content provider may include watermark/fingerprint traceability information, as well as registration and other information. Such information may be employed by the market upstream content provider to trace points of origin of possible unauthorized content use.

Aggregator 106 may select to transmit content in the clear (unencrypted) to at least one service operator(s) 110. Aggregator 106 may also select to transmit encrypted content to at least one service operator(s) 110. Aggregator 106 may select to transmit the originally received encrypted content. Alternatively, Aggregator 106 may select to transmit the unencrypted, fingerprinted/watermarked content by re-encrypting the unencrypted content.

If aggregator 106 selects to transmit encrypted content, the encrypted content is communicated to key wrap 226 wherein the encrypted content is ‘wrapped’ with a signed and encrypted wrapper. Moreover, an identifier that is uniquely associated with aggregator 106 may be included within the key wrap.

As the content is received by the particular service operator(s) 110, substantially similar processes as described above may be performed, until the encrypted/unencrypted content is transmitted to user(s) 114.

### Process of Uniquely Identifying Content

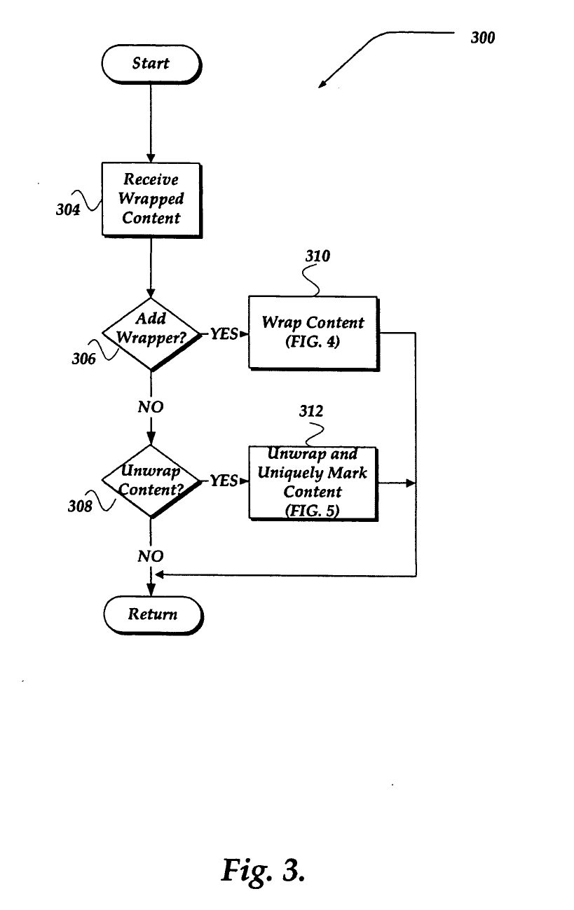

FIGS. 3-5 are flow diagrams generally illustrating embodiments of exemplary processes of uniquely identifying highly distributed content. The processes illustrated in FIGS. 3-5 may be employed by aggregator(s) 106 and service operators(s) 110 of FIG. 1.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

Referring to FIG. 3, process 300 begins, after a start block, at block 304 where a wrapped encrypted content packet is received. The encrypted content packet is typically wrapped initially by an upstream market provider, such as content owner 102 in FIG. 1. Process flow proceeds to decision block 306.

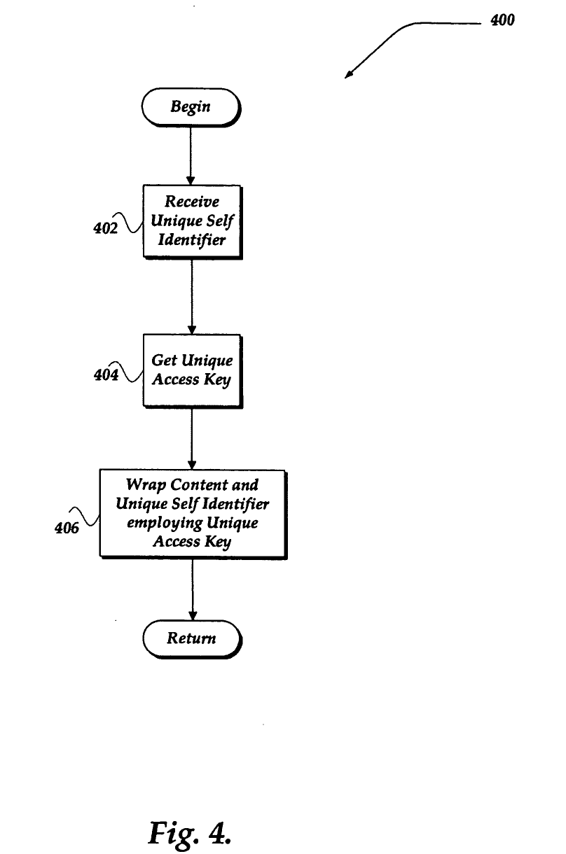

At decision block 306, a determination is made whether the wrapped encrypted content packet is to have another wrapper appended to the packet. If it is determined that another wrapper is to be appended, process control flow proceeds to block 310. Block 310 is described below in conjunction with FIG. 4. Briefly, however, at block 310, the encrypted content is key wrapped (encrypted) with an access key that is unique to the current market participant and to the intended downstream market recipient. Upon completion of block 310, process 300 returns to performing other actions.

If at decision block 306, however, it is determined that another wrapper is not to be appended to the received wrapped encrypted content packet, process flow proceeds to decision block 308.

At decision block 308, a determination is made whether the received wrapped encrypted content packet is to be unwrapped (decrypted). If it is determined that the wrapped encrypted content packet is not to be unwrapped, process 300 returns to perform other actions.

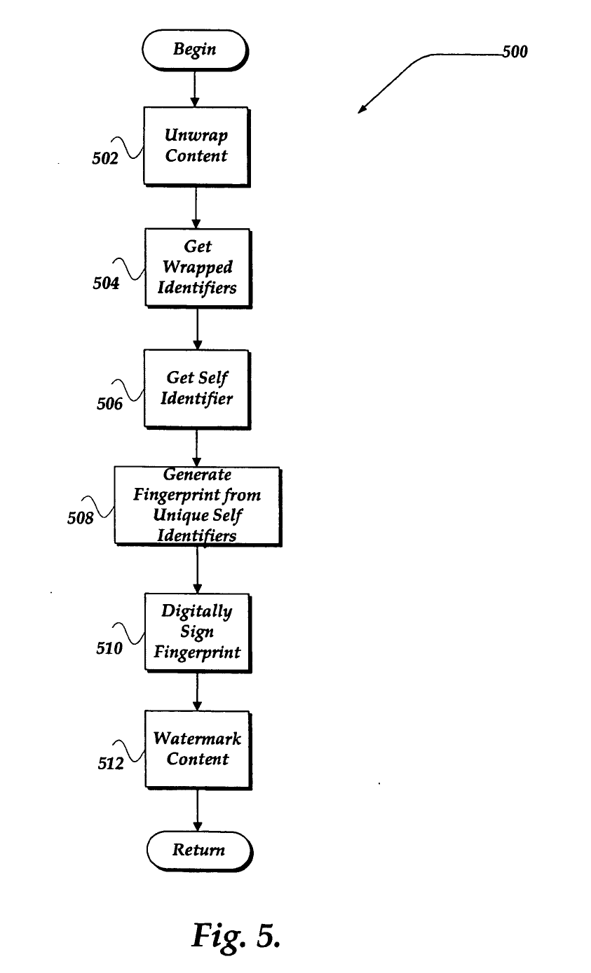

If, however, at decision block 308, it is determined that the received wrapped encrypted content packet is to be unwrapped, the process continues to block 312. The actions at block 312 are described below in conjunction with FIG. 5. Briefly, however, at block 312, the encrypted content is unwrapped and decrypted. The decrypted content is watermarked with a unique fingerprint. Upon completion of block 312, process 300 returns to processing other actions.

### Wrapping Content Process

FIG. 4 is a flow diagram illustrating an embodiment of a process of wrapping encrypted content as described above at block 310 in FIG. 3. Process 400 of FIG. 4 begins, after a start block, at block 402.

At block 402, a unique self-identifier is received. Typically, the self-identifier includes information that uniquely associates a particular market participant to the wrapper to be appended to the content packet. For example, the identifier could be a unique serial number identifying the current market participant. The identifier may also include a time stamp representing when the wrapper is created. After the self-identifier is received, process flow continues to block 404.

At block 404, an access key is received. The access key may be implemented in any of a number of encryption techniques, including, but not limited to, DES, Triple DES, and AES. The access key may also be configured to support a Public Key Infrastructure (PKI). Whatever technology is employed, the access key received is uniquely associated with a particular downstream market recipient. The process flow proceeds to block 406.

At block 406, the unique access key is employed to ‘wrap’ the encrypted content and the unique self-identifier with a signed and encrypted wrapper. The unique access key associated with the particular downstream market recipient is typically communicated to that particular recipient through an out-of-band transfer, so that the downstream market recipient may unwrap the wrapped encrypted content. Upon completion of block 406, process 400 returns to process 300 in FIG. 3, to perform other actions.

### Watermarking Content Process

FIG. 5 is a flow diagram illustrating an embodiment of a process 500 of uniquely watermarking unencrypted content, described above at block 312 in FIG. 3. Process 500 of FIG. 5 begins, after a start block, at block 502.

At block 502, wrapped encrypted content and the unique self-identifier(s) of the upstream market provider(s) are unwrapped (decrypted) employing the unique access key communicated during an out-of-band transfer. If the content is wrapped with multiple wrappers, multiple unwrappings may be performed to obtain the content owner's access key. The content owner's access key is employed to decrypt the encrypted content. The process flow continues to block 504.

At block 504, the unique self-identifier(s) of the upstream market provider(s) are extracted from the unwrapped encrypted content. If the content is wrapped with multiple wrappers, multiple self-identifiers may be extracted. Process flow control continues to block 506.

At block 506, a unique self-identifier for the current market participant is received. The process proceeds to block 508.

At block 508, a unique fingerprint is created. In one embodiment, the fingerprint includes information about the unique self-identifier(s) obtained in blocks 504 and 506. In another embodiment, the fingerprint may also include information about the content owner. The process continues to block 510.

At block 510, the fingerprint is digitally signed typically employing a private/public key technology, or similar technology that provides for non-repudiation of the digital signature. The process flow proceeds to block 512.

At block 512, the digitally signed fingerprint is embedded in the content employing any of a variety of watermarking technologies. In one embodiment of the present invention the public key associated with the private key employed in digitally signing the fingerprint is also embedded in the content via a watermarking technology. Upon completion of block 512, process 500 returns to process 300 in FIG. 3, to perform other actions.

The above specification, examples, and data provide a complete description of the manufacture and use of the embodiments of the invention. However, many other embodiments of the invention can be made without departing from the spirit and scope of the invention.

We claim:

1. A method for tracing content in a highly distributed system, comprising:
receiving content associated with a content owner;
decrypting the received content;
associating a first set of information with the decrypted content, wherein the first set of information, in part, uniquely identifies an entity decrypting the content; and
providing a second set of information to the content owner, wherein the second set of information enables the content owner to trace the content in the highly distributed system.

2. The method of claim 1, wherein decrypting the received content further comprises:
obtaining an access key out-of-band, wherein the access key is uniquely associated with the entity decrypting the content and a sender of the content; and
employing the access key to unwrap the received content.

3. The method of claim 1, wherein associating the first set of information further comprises:
determining a self-identifier associated with the entity decrypting the content;
determining a fingerprint based, in part, on the self-identifier; and
watermarking the decrypted content employing the fingerprint.

4. The method of claim 3, wherein the self-identifier is digitally signed by an encryption key associated with the entity decrypting the content.

5. The method of claim 3, wherein the self-identifier further comprises at least one of a serial number, and a time stamp indicating approximately when the content is decrypted.

6. The method of claim 1, wherein the second set of information further comprises at least one of traceability information, a time stamp, an identifier, and registration information associated with at least one of the content and the entity decrypting the content.

7. The method of claim 1, further comprising:
determining a self-identifier associated with the entity decrypting the content;
determining an access key associated with another recipient of the content and the entity;
encrypting the content;
wrapping the encrypted content and the self-identifier employing the access key;
forwarding the wrapped and encrypted content to the other recipient.

8. The method of claim 7, wherein determining the access key further comprises receiving the access key employing an out-of-band mechanism.

9. The method of claim 7, wherein wrapping the encrypted content further comprises digitally signing the encrypted content.

10. The method of claim 7, wherein the access key employs a public key infrastructure.

11. The method of claim 1, wherein the content is at least one of a subscription television, movies, interactive video games, video conferencing, audio, still images, text, graphics.

12. A security device for tracing content in a highly distributed system, comprising:
a receiver configured to receive content associated with a content owner;
a fingerprinter-watermarker configured to perform actions including:
determining a self-identifier that uniquely identifies a recipient of the content;
determining a fingerprint based, in part, on the self-identifier; and
watermarking the content employing the fingerprint; and
a forensics interface configured to send information associated with the watermarked content to the content owner.

13. The security device of claim 12, further comprising:
a key wrap, coupled to the fingerprinter-watermarker, that is configured to perform actions, including:
receiving an access key associated with the recipient of the content; and
wrapping the content and the self identifier employing the access key.

14. The security device of claim 13, wherein the access key is received employing an out-of-band mechanism.

15. The security device of claim 12, wherein the recipient is at least one of an aggregator, a service operator, and a user.

16. The security device of claim 12, wherein the information associated with the watermarked content comprises at least one of traceability information, a time stamp, an identifier, and registration information associated with at least one of the content and the recipient of the content.

17. The security device of claim 12, further comprising:
a data store configured to store decrypted content; and
a fingerprinted-watermarked content data store configured to store encrypted content.

18. A modulated data signal having computer executable instructions embodied thereon for delivering content in a highly distributed system, the modulated data signal comprising actions including:
transferring content from a market participant to another market participant;
enabling a decryption of the content, if the transferred content is encrypted;
enabling an association of information with the decrypted content, wherein the information uniquely identifies an entity associated with the decryption of the content; and
providing the information concerning the decrypted content to the content owner.

19. The modulated data signal of claim 18, wherein information associated with the content further comprises at least one of a fingerprint, a watermark, a time stamp, and a serial number.

20. An apparatus for tracing content in a highly distributed system, comprising:
a means for receiving content associated with a content owner;
a decryption means for decrypting the received content;
a means for associating a first set of information with the decrypted content, wherein the first set of information, in part, uniquely identifies an entity decrypting the content;
a means for determining a second set of information associated with the decryption of the content; and
a means for providing the second set of information to the content owner.
